(19) United States
(12) Patent Application Publication
(10) Pub. No.: US 2006/0225832 A1
(43) Pub. Date: Oct. 12, 2006

(54) METHOD FOR DISPENSING AN ENERGY REACTIVE ADHESIVE

(76) Inventors: Laurence B. Saidman, Duluth, GA (US); John M. Raterman, Atlanta, GA (US); Khaled Anis, Oldsmar, FL (US)

Correspondence Address: WOOD, HERRON & EVANS, LLP (NORDSON), 2700 CAREW TOWER, 441 VINE STREET, CINCINNATI, OH, 45202, US

(21) Appl. No.: 10/907,348

(22) Filed: Mar. 30, 2005

(51) Int. Cl. B32B 37/00

(52) U.S. Cl. 156/247; 156/272.2

(57) ABSTRACT

A method uses energy reactive adhesive to temporarily unitize packages. Particular placement of the reactive adhesive allows the packages to be bonded until exposure to ultraviolet light or other radiated energy having a wavelength of less than about 700 nanometers causes a photoinitiator or other catalyst in the reactive adhesive to reduce the temporary bond. Once the bond has reduced, the packages may be easily separated for stocking with minimal adhesive residue.

### FIELD OF THE INVENTION

The present invention generally relates to an adhesive dispensing system, and more particularly, to an adhesive dispensing system for temporarily unitizing substrate surfaces.

### BACKGROUND OF THE INVENTION

When cartons, packages or bags are adjacently stacked, it is often desirable that the items remain temporarily in a stable group, or unitized. Unitization is particularly advantageous in the context of warehousing, palletizing and transportation operations. For example, large numbers of packages may be piled onto wooden pallets and moved from different locations on forklifts. The pallets are raised on elevators for warehouse storage, or for long distance transport. When the stored item is actually used, the cartons are de-unitized, or separated, so that a single package can be picked up and carried, for example, by a plant operator.

Conventional materials used to unitize package, bag, pallet and other substrate surfaces include tape, glues, hot melt adhesives, plastic straps and stretch wrap films. While these materials and their associated application processes generally succeed in securing packages to each other and/or a pallet, the subsequent de-unitizing of the substrates can be problematic. For example, conventional adhesives may damage package surfaces upon separation. Conventional adhesives routinely leave sticky balls or other residue along formerly bonded surfaces when packages are removed from each other or the pallet. Adhesive placement and tackiness often makes carton removal from a pallet difficult, requiring exertion and/or tools, such as shears or a crowbar. Such separation practices can damage graphics and compromise package integrity.

There is consequently a need for improved bonding methods that bond substrate surfaces in a manner that facilitates de-unitization.

### SUMMARY OF THE INVENTION

The present invention provides improved fluid dispensing processes configured to securely unitize substrates in manners that address the problems of the prior art. In one aspect, the invention includes a method for applying an energy reactive adhesive to a first surface of a surface on a substrate. For instance, the energy reactive adhesive may be sprayed or otherwise applied onto the substrate as it moves along a conveyor. The first surface of the substrate is temporarily bonded to a second surface using the energy reactive adhesive. The first and second surfaces may then be moved as a single unit. For example, a number of cartons can be adhesively secured together for movement or storage.

The bonding capability of the energy reactive adhesive is reduced when exposed to a source for radiating energy within the electromagnetic spectrum, excluding infrared radiation. A typical source for radiating energy radiates ultraviolet light. The reactive adhesive is exposed to the source for radiating energy when de-unitized. To this end, a mechanical arm may be used to separate the first and second surfaces in order to better expose the energy reactive adhesive to the source for radiating energy. The radiation exposure causes the temporary bonding characteristics of the light reactive adhesive to be reduced, so that a package, bag, carton, box or other container, and/or a pallet or other substrate may consequently be easily separated without tearing or defacing their outer surfaces. As such, substrates are economically and efficiently unitized and de-unitized in a manner that mitigates or eliminates residue and surface damage.

These and other objects and advantages of the present invention will become more readily apparent during the following detailed description taken in conjunction with the drawings herein.

### BRIEF DESCRIPTION OF THE DRAWINGS

FIG. 1 is a block diagram of a fluid dispensing system for applying energy reactive adhesive to substrate surfaces in accordance with the principles of the present invention.

FIG. 2 is a block diagram showing a substrate of FIG. 1 temporarily bonded to another substrate with the energy reactive adhesive.

FIG. 3 is a block diagram showing the energy reactive adhesive and substrates of FIG. 2 being exposed to light from a source used to reduce the bonding characteristics of the energy reactive adhesive.

FIG. 4 is a flowchart showing in greater detail the processes used in FIGS. 1-3 to temporarily bond and de-unitize substrate surfaces.

### DETAILED DESCRIPTION OF THE INVENTION

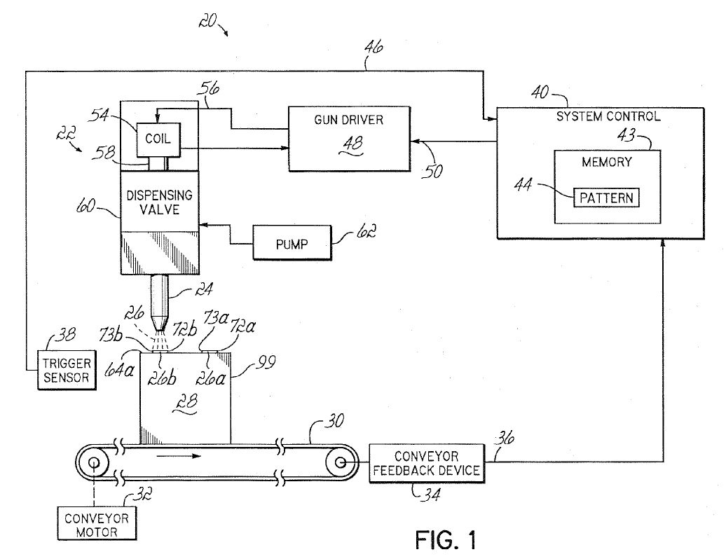

FIG. 1 shows a block diagram of a fluid dispensing system 20 configured to facilitate unitization by applying an energy reactive bonding agent, or adhesive 26, to cartons or other substrate surfaces 64a. A suitable energy reactive adhesive 26 comprises a material whose bonding properties, e.g., tackiness, are reduced when exposed to a source that radiates energy in one or more spectrums of the electromagnetic spectrum, excluding infrared radiation, i.e., heat. For instance, the energy reactive adhesive 26 typically comprises a thermoplastic material that is tacky under ambient conditions and that becomes brittle when subject to a radiating energy source. That is, the tackiness of the energy reactive adhesive 26 is reduced when exposed to the source that radiates energy. In one preferred embodiment, the radiating energy source includes an ultraviolet light source.

The system 20 applies the energy reactive adhesive 26 on and/or between substrate surfaces, and upon setting (which may be immediate or nearly immediate), yields a bond having high shear strength and tensile forces. The bond helps prevent the substrates 28 from sliding across one another during warehousing operations, such as forklift maneuvers, palletizing, storage and/or subsequent transport.

Conversely, the temporary bond formed between the substrate surfaces is readily reduced from exposure to a positioned source for radiating energy. After the subsequent exposure to the radiated energy, the substrates separate and lift off of a pallet or other substrate surface easily, causing little or no damage to package graphics. While suitable energy radiating sources may include devices that radiate energies having wavelengths of less than about 700 nanometers, the system 20 shown in FIG. 1 is configured for use with an ultraviolet light source, i.e., a source radiating energy having wavelengths ranging from about 40 nanometers to about 400 nanometers.

The dispensing system 20 of FIG. 1 may accurately and efficiently apply the energy reactive adhesive 26. For instance, one spray pattern 44 used by the system 20 may place dots of the energy reactive adhesive 26 along a surface 64a of a substrate 28 that will later be exposed to ultraviolet light. The frequency and volume of the dots is sufficient to unitize substrate surfaces, and the dots are advantageously located along a surface 64a that is readily exposed to radiated energy comprising the ultraviolet light during de-unitization. In this manner, the precise placement provided by the system 20 translates into less waste, sufficient bonding and eventual ease of de-unitization. One skilled in the art will appreciate that other pattern applications and adhesive placements may be used in accordance with the principles of the present invention and per application specifications.

Referring more particularly to FIG. 1, a fluid dispensing gun 22 of the system 20 comprises a nozzle 24 for dispensing the energy reactive adhesive 26. The energy reactive adhesive 26 typically includes a photoinitiator. A photoinitiator is a compound that upon absorption of light undergoes a photoreaction that produces reactive species. These species are capable of initiating, or catalyzing, chemical reactions that result in significant changes in the solubility, tackiness and/or other physical properties of an adhesive mixture. The photoinitiator may be mixed with a rubber, epoxy, vinyl, acrylic adhesive or other mixing agents to produce desirable tackiness. The energy reactive adhesive 26 may additionally be optimized for viscosity and other properties aiding in the automatic dispensing and storage of the adhesive 26.

Particularly advantageous temporary bonding characteristics may be achieved using high vinyl styrene-butadiene-styrene (SBS) or rubber-based pressure sensitive adhesives mixed with a photoinitiator. For example, a commercially available formulation of energy reactive adhesive available from Kraton Polymers, Inc. of Houston, Tex., which comprises KX-222 high vinyl SBS with at least five parts per hundred of Ergacure 651 photoinitiator, has proven to be particularly effective in temporarily unitizing substrates. One skilled in the art will further appreciate that while a combination of SBS-based pressure sensitive adhesive with a photoinitiator may have particular advantages in certain embodiments, other energy reactive adhesives may be substituted in accordance with the principles of the underlying invention. For instance, while radical photoinitiators may be particularly advantageous in certain embodiments, one skilled in the art will appreciate that other photoinitiators, including cationic photoinitiators, may have equal application.

In any case, the photoinitiator of the energy reactive adhesive 26 will not react with a mixing agent by itself. The photoinitiator of one preferred embodiment must absorb ultraviolet light before the photoinitiator will undergo a chemical reaction. That reaction may produce byproducts that cause the energy reactive adhesive 26 to harden. More particularly, the light transforms the tacky (adhering) energy reactive adhesive 26 into a hard and non-tacky (non-adhering) cross-linked polymer network.

A conveyor 30 of the system 20 carries the substrate 28 past the dispensing gun 22. The conveyor 30 is mechanically coupled to a conveyor drive having a conveyor motor 32. A conveyor feedback device 34, for example, an encoder, resolver, etc., is mechanically coupled to the conveyor 30 and detects conveyor motion. The feedback device 34 is used by a system control 40 to determine the position of the substrate 28. This positional information, in turn, may be used to determine when processes for applying light reactive adhesive should be initiated for optimal adhesive placement.

The system control 40 generally functions to coordinate the operation of the overall dispensing system 20. For example, the system control 40 typically controls the operation of the conveyor motor 32 and also provides a system user input/output interface (not shown) in a known manner. Further, the system control 40 manages the dispensing gun 22 as a function of a particular application and/or part being run.

The system control 40 receives, on an input 46, a part present or trigger signal from a trigger sensor 38. The trigger sensor 38 is positioned to detect a feature, for example, a leading edge 99 of the substrate 28 moving on the conveyor 30. For instance, the trigger sensor 38 may detect the leading edge of a carton flap or pallet. The trigger sensor 38 may comprise a photocell or other proximity sensor.

A gun driver 48 is responsive to command signals 50 from the control 40 and provides output signals 56 to a dispensing gun coil 54. The output signals 56 energize and de-energize the gun coil 54 to operate the dispensing gun 22 as a function of the timing and duration of the command signals 50 from the system control 40. More particularly, the signals 56 from the gun driver 48 creates current flow through the gun coil 54, thereby building up a magnetic field that lifts an armature 58 and a dispensing valve 60 connected thereto, applying the energy reactive adhesive 26 onto the moving substrate 28. While the above-described gun coil embodiment is effective in dispensing energy reactive adhesive, other dispensers known in the art may be used to dispense energy reactive adhesive in accordance with the principles of the present invention.

As shown in FIG. 1, the dispensing valve 60 is fluidly connected to a pump 62. The pump 62 receives energy reactive adhesive 26 from a reservoir. The photoinitiator of the adhesive 26 generally requires no special temperature conditions. Upon the dispensing valve 60 opening, pressurized energy reactive adhesive 26 in the dispensing gun 22 passes through the nozzle 24 and is applied to a surface 64a of a substrate 28 as a deposit, for example, as a dot, a bead, a strip, etc.

A memory 43 of the system control 40 typically stores an adhesive dispensing pattern 44. The adhesive dispensing pattern 44 represents a series of dispensing cycles associated with a substrate 28 that result in a desired pattern of energy reactive adhesive deposits 26 thereon. For instance, the pattern 44 is used along with the dispensing program 45 to accurately place the energy reactive adhesive 26 in a manner that optimizes both temporary adhesion and eventual exposure to radiating energy.

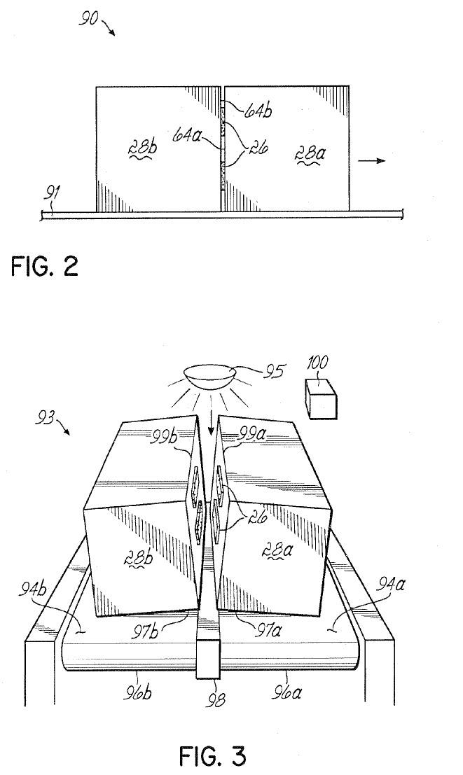

FIG. 2 shows two package substrates 28a, 28b that are temporarily bonded along their respective contacting surfaces 64a, 64b with an energy reactive adhesive 26. The package substrates 28a, 28b in FIG. 2 are shown positioned on a conveyor surface 91. In one application, it is desirable to unitize such substrates 28a, 28b prior to their arrival at a palletizing machine configured to palletize two substrates at once. The energy reactive adhesive 26 may have been applied to one or both of the contacting surfaces 64a, 64b using the dispensing system 20 shown in FIG. 1. For instance, the system 20 may have applied a row of dots along the surface 64a of the first substrate 28a.

Through conveyance and other automated processes, the package substrate 28a and adhesive 26 may have been subsequently oriented and/or contacted with the surface 64b of the second package substrate 28b. While shown in FIG. 2 as comprising part of a like substrate, one skilled in the art will appreciate that the surface 64a may have alternatively been palletized to a surface of a pallet or another type of substrate.

The energy reactive adhesive 26 shown in FIG. 2 has temporarily bonded the substrate surfaces 64a, 64b. While setting times may vary per adhesive, substrate material, temperature and other environmental conditions, one gram of a typical energy reactive adhesive 26 typically sets by cooling about twenty to thirty seconds. Once temporarily bonded, the bonded substrates 28a and 28b may be further packaged, stored and/or transported as a bonded unit. For instance, the substrates 28a and 28b may be shipped to another site on a pallet.

FIG. 3 shows the package substrates 28a, 28b of FIG. 2 positioned a pair of conveyor belts 96a, 96b having a moveable arm 98 juxtaposed therebetween. The arm 98 typically resides below the conveying surfaces 94a, 94b of the conveyor belts 96a, 96b. When a photoeye 100 or other detector situated along the path of the conveyor belts 96a, 96b senses an approaching substrate 28, a signal may be sent to the arm 98 that causes it to vertically rise above a plane defined by the surfaces 94a, 94b of the conveyor belts 96a, 96b. As the conveyor belts 96a, 96b move the substrates 28a, 28b into the proximity of the raised arm 98, the substrates 28a, 28b are made to contact the arm 98. For instance, the arm 98 may automatically rise when the substrates 28a, 28b are positioned on top of the arm 98 when resting in its lowered position.

The upward movement of the arm 98 may communicate forces to the bottom surfaces 97a, 97b of the substrates 28a, 28b causing the top surfaces 99a, 99b of the substrates 28a, 28b to separate. This separation allows energy radiating from the source 95 for radiating energy to reach the energy reactive adhesive 26. In another embodiment, the arm may be stationary and the substrates may be made to bump into or slide over the arm to achieve a similar separation. In any case, the system 93 uses mechanical forces transferred by the arm 98 to the substrates 28a, 28b to achieve communication between the radiating energy source 95 and the energy reactive adhesive 26.

More particularly, the arm 98 shown in FIG. 3 is raised to contact the underside and contacting corners 97a, 97b of the substrates 28a, 28b along their temporarily bonded surfaces 64a, 64b. Forces from the arm 98 communicated to the temporarily bonded surfaces 64a, 64b cause the surfaces 64a, 64b to form a gap into which light energy may travel. This gap along the top corners 99a, 99b of the bonding surfaces 64a, 64b exposes the energy reactive adhesive 26 to ultraviolet light from the source 95. The source 95 may constantly radiate energy, or may alternatively selectively radiate energy in synchronization with movement of the arm 98 and/or the movement of the substrates 28a, 28b as determined by the photoeye 100. That is, the emission of radiation from the source 95 may be initiated in response to the photoeye's 100 detection of the substrate 28a, 28b . While the source 95 is typically stationary, a source of another embodiment may be handheld.

The arm 98 may return to its original, lowered position after the reactive adhesive 26 has been exposed. In another embodiment, a comparable arm, or ridge may continuously remain above the surface of the conveyor surfaces to create a gap between the substrates as they roll over the ridge. One skilled in the art will recognize that there are a number of other manners in which a gap between substrate surfaces may be formed to facilitate light exposure in accordance with the principles of the present invention.

Where the radiating source comprises an ultraviolet light, for example, the temporary bond of the light reactive adhesive 26 begins to destabilize, or weaken, in response to the light exposure. For instance, the photoinitiator of the energy reactive adhesive 26 may become activated, cross-linking the styrene-butadiene-styrene. This cross-linking dramatically reduces the tackiness of the adhesive 26.

Only a short light exposure is typically required to sufficiently destabilize the temporary bond. Once destabilized, substrates 28a, 28b may be readily separated off of the conveyor 96a, 96b or pallet. Moreover, the energy reactive adhesive 26 does not damage graphics or form sticky balls associated with some fugitive adhesives and tape, among other conventional unitizing materials.

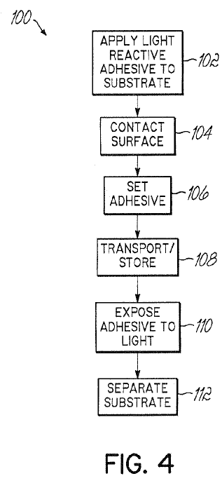

FIG. 4 is a flowchart 100 showing in greater detail the processes used in FIGS. 1-3 to temporarily bond and de-unitize substrate surfaces 64a, 64b. At block 102 of FIG. 4, the dispensing system 20 applies the energy reactive adhesive 26 to a substrate surface 64a. While an aspect of the invention may capitalize the precision and speed of automated dispensing systems, the energy reactive adhesive 26 may alternatively be manually applied in any known manner. The substrate surface 64a is made to contact at block 104 another surface 64b before the energy reactive adhesive 26 sets.

The adhesive sets at block 106, temporarily bonding the substrate surfaces 64a and 64b. The time needed for curing the adhesive 26 may vary and/or be accelerated using blowers and temperature variance, as is known in the art.

Once unitized at block 106, the bonded substrates 28 may be manipulated at block 108 as a single unit. For instance, the unitized substrates 28a and 28b may be conveyed or otherwise transported to a next processing station, e.g., a machine for palletizing substrates that more efficiently processes two substrates at a time. Another example may include a scenario where it is more efficient to transport palletized or otherwise unitized substrates in a warehouse while they await shipment.

The system 20 applies the energy reactive adhesive 26 in a manner that takes into account that the adhesive 26 must ultimately be exposed to a radiating source 95. The placement and amount of the energy reactive adhesive 26 applied may consequently be influenced by the manner in which the energy radiating source 95 is intended to communicate with the substrates 28a, 28b and adhesive 26. For instance, the adhesive 26 may be dispensed on a portion of a surface of a substrate that will be closest and/or most exposed to the source during de-unitization.

At such time as it becomes desirable to de-unitize the substrates 28a, 28b, the energy reactive adhesive 26 is exposed at block 110 to energy from a source 95. The radiating source 95 typically emits ultraviolet light, but for purposes of this specification may alternatively produce energy having any wavelength and frequency of the electromagnetic spectrum, other than of infrared radiation. That is, wavelengths are typically near ultraviolet light (40-400 nanometers range), but energies associated with other wavelengths may alternatively be used. For instance, photoinitiators expanding into the visible light range, or on the blue side to deep ultraviolet, may be commonly used. In any case, the radiated energy is suited to reduce the bonding characteristics of the energy reactive adhesive 26.

The unitized substrates 28a and 29b may be manipulated to increase the exposure of the light reactive adhesive 26. For example, the substrates 28a, 28b may have mechanical forces automatically or manually applied to them in order to maximize the light exposure of the light reactive adhesive 26.

The de-unitized substrates 28a and 28b are separated at block 112 of FIG. 4. That is, once the light reactive adhesive 26 has at block 110 lost all or some of its tackiness, users may readily separate the substrates 28a, 28b for individual shipping, transport and/or stocking.

An aspect of the invention capitalizes on the accuracy of dispenser systems 20 to strategically and efficiently apply the energy reactive adhesive 26 on and/or between substrate surfaces 28a, 28b. The placement and properties of the adhesive 26 yield a bond having high shear strength and tensile forces upon curing. The bond helps prevent the substrates 28a, 28b from sliding across one another during warehousing operations, such as forklift maneuvers, storage, pre-palletizing and/or subsequent transport. Conversely, the temporary bond formed between the substrate surfaces 28a, 28b is readily reduced from exposure to the positioned radiating source.

The reactive adhesive 26 provides a number of advantages over known unitizing systems, providing packagers with relatively inexpensive and stable method of temporary bonding substrate surfaces. Moreover, this unitizing is accomplished without the residue and adverse affects of some cold glues, scored tape or hot melt adhesives. Further, the reactive adhesive 26 typically does not include any volatile organic compounds.

Because the reactive adhesive produces neither solid waste nor surface damage, the adhesive 26 does not interfere with the reading of graphics or product codes. Moreover, the reactive adhesive 26 can be applied in a very thin layer. The layer may be clean and clear when set. Substrate surfaces 28a, 28b do not re-bond to one another after they are separated.

The reactive adhesive 26 is further ideal for automated dispensing operations or integration into automatic palletizers, increasing throughput. The reactive adhesive may be prepared and stored for long periods. In one embodiment, the de-unitized adhesive layer is chemically and physically resistant, providing additional protection to cardboard, paper, plastics, wood or metal substrate.

While the present invention has been illustrated by a description of various embodiments and while these embodiments have been described in considerable detail in order to describe a mode of practicing the invention, it is not the intention of Applicants to restrict or in any way limit the scope of the appended claims to such detail. Additional advantages and modifications within the spirit and scope of the invention will readily appear to those skilled in the art.

What is claimed is:

1. A method of temporarily bonding a first surface on a substrate to a second surface for packaging or transport, the method comprising:
applying an energy reactive adhesive to at least one of the first or second surfaces, wherein a bonding capability of the energy reactive adhesive is reduced when exposed to a source for radiating energy within the electromagnetic spectrum below a wavelength of about 700 nanometers; and
temporarily bonding the first surface to the second surface using the energy reactive adhesive.

2. The method of claim 1, further comprising:
exposing the energy reactive adhesive to the source to reduce the bonding capability of the energy reactive adhesive; and
separating the first and second surfaces.

3. The method of claim 2, further comprising:
moving the temporarily bonded first and second surfaces as a single unit prior to exposing the energy reactive adhesive.

4. The method of claim 2, wherein separating the first and second surfaces further comprises:
using a mechanically moveable armature to separate the first and second surfaces.

5. The method of claim 2, further comprising:
storing the temporarily bonded first and second surfaces as a single unit prior to exposing the energy reactive adhesive.

6. The method of claim 2, further comprising:
palletizing the temporarily bonded first and second surfaces as a single unit prior to exposing the energy reactive adhesive.

7. The method of claim 2, wherein exposing the light reactive adhesive further comprises:
exposing the energy reactive adhesive to a light source.

8. The method of claim 7, wherein exposing the light reactive adhesive further comprises:
exposing the energy reactive adhesive to an ultraviolet light source.

9. The method of claim 1, further comprising:
exposing the energy reactive adhesive to the source while at least partially separating the first and second surfaces.

10. The method of claim 1, wherein applying the energy reactive adhesive further comprises:
applying the energy reactive adhesive to the first surface of at least one of a container and a pallet.

11. The method of claim 1, wherein applying the energy reactive adhesive further comprises:
applying a photoinitiator.

12. A method of de-unitizing a first surface on a substrate from a second surface, the method comprising:
receiving the temporarily bonded first and second surfaces as a single unit;
exposing the energy reactive adhesive to the radiating energy to reduce the bonding capability of the energy reactive adhesive; and
separating the first and second surfaces.

13. The method of claim 12, wherein separating the first and second surfaces further comprises:
separating first surface of at least one of a container and a pallet.

14. The method of claim 12, wherein exposing the light reactive adhesive further comprises:
exposing the energy reactive adhesive to a light source.

15. The method of claim 12, wherein exposing the light reactive adhesive further comprises:
exposing the energy reactive adhesive to an ultraviolet light source.

16. The method of claim 12, further comprising:
exposing the energy reactive adhesive to the source while at least partially separating the first and second surfaces.

17. A method of transporting a unit comprising a first surface of a substrate a second surface, wherein the first and second surfaces are temporarily bonded together using an energy reactive adhesive having a bonding capability that is reduced when exposed to a source for radiating energy within the electromagnetic spectrum below a wavelength of about 700 nanometers, the method comprising:
receiving the temporarily bonded first and second surfaces as a single unit; and
transporting the first and second surfaces as the unit.

18. A method of dispensing a thermoplastic material that is tacky at an ambient temperature and capable of temporarily bonding a plurality of substrates together, the method comprising:
dispensing the thermoplastic material onto at least one of the plurality of substrates; and
exposing the thermoplastic material to a source for radiating energy to reduce the tackiness of the thermoplastic material.

19. The method of claim 18, wherein dispensing the thermoplastic material further comprises dispensing an adhesive.

20. The method of claim 18, wherein exposing the thermoplastic material to a source for radiating energy further comprises exposing the thermoplastic material to a source for radiating energy within the electromagnetic spectrum below a wavelength of about 700 nanometers.

21. The method of claim 18, further comprising un-bonding the plurality of substrates after the exposing of the thermoplastic material.

22. The method of claim 18, further comprising transporting the plurality of substrates as a single unit after the dispensing of the thermoplastic material.
